(19) United States
(12) Patent Application Publication
(10) Pub. No.: US 2012/0166731 A1
(43) Pub. Date: Jun. 28, 2012

(54) COMPUTING PLATFORM POWER MANAGEMENT WITH ADAPTIVE CACHE FLUSH

(76) Inventors: CHRISTIAN MACIOCCO, Portland, OR (US); REN WANG, Portland, OR (US); TSUNG-YUAN C. TAI, Portland, OR (US)

(21) Appl. No.: 12/975,458

(22) Filed: Dec. 22, 2010

(51) Int. Cl. G06F 12/08

(52) U.S. Cl. 711/130; 711/135; 711/E12.022; 711/E12.038

(57) ABSTRACT

In some embodiments, an adaptive break-even time, based on the load level of the cache, may be employed.

### TECHNICAL FIELD

The present invention relates generally to power state management for a computing platform or platform component's such as a CPU.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a computing platform with adaptive cache flushing in accordance with some embodiments.

FIG. 2 is a flow diagram showing a routine for implementing adaptive cache flushing in accordance with some embodiments.

### DETAILED DESCRIPTION

Computing platforms commonly use power management systems such as ACPI (the Advanced Configuration and Power Interface) to save power by operating the platform in different power states, depending on required activity, e.g., as dictated by application and external network activity. The power management system may be implemented in software (e.g., from the operating system) and/or in hardware/firmware, depending on design tastes for a given manufacturer. For example, CPU or processor cores and their associated performance level may be regulated using so-called P states and their power saving level using so-called C states.

In the deeper power reduction states (e.g., C6 or C7 states and package level C state where all cores achieve the same C state simultaneously), processor cache, e.g., so-called last-level cache, may be “flushed” to save power. Flushing refers to transferring the cache data to other memory such as main memory and then powering down the cache to save power. Different processors use different pre-defined algorithms or heuristics to flush their last level cache (LLC) to save energy.

U.S. patent application Ser. No. 12/317,967, entitled: PLATFORM AND PROCESSOR POWER MANAGEMENT, filed on Dec. 31, 2008, incorporated by reference herein, describes methods of having devices report their “idle duration” to optimize processor and system energy efficiency, where the CPU/package can “safely” shrink the LLC in one shot knowing that an idle duration is coming. In this method, an upcoming idle duration is compared with a fixed break even-time to decide if it would be worthwhile (from an energy benefit point of view) to flush the cache. However, closing and re-populating different cache sizes incurs different overhead in terms of power consumption and latency. Thus, a fixed break-even time may not be desirable for all situations. Accordingly, a new approach may be desired.

In some embodiments, an adaptive break-even time, based on the load level of the cache, may be employed. This may provide more opportunities to flush the cache and allow a processor/package to reach lower power states properly.

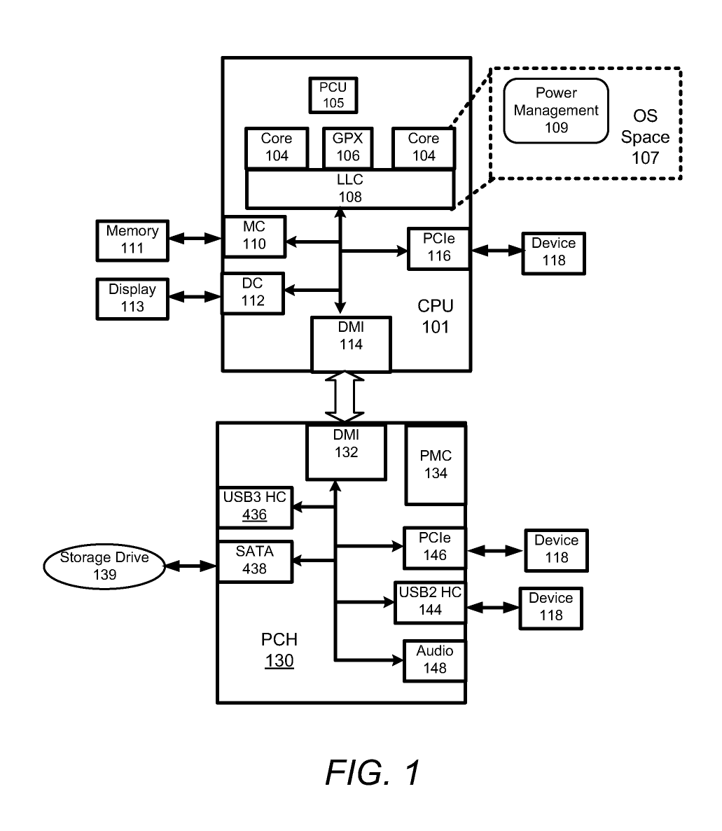

FIG. 1 is a diagram of a multi-core computing platform with adaptive cache flush in accordance with some embodiments. The depicted platform comprises a CPU chip 102 coupled to a platform control hub 130 via a direct media interconnect (DMI) interface 114/132. The platform also includes memory 111 (e.g., DRAM) coupled through a memory controller 110 and a display 113 coupled through a display controller 112. It also includes a storage drive 139 (e.g., a solid state drive) coupled through a drive controller such as the depicted SATA controller 138. It may also include devices 118 (e.g., network interface, WiFi interface, printer, camera, cellular network interface, etc.) coupled through platform interfaces such as PCI Express (116 in the CPU chip and 146 in the PCH chip) and USB interfaces 136, 144.

The CPU chip 101 comprises processor cores 104, a graphics processor 106, and last level cache (LLC) 108. One or more of the cores 404 execute operating system software (OS space) 107, which comprises a power management program 109.

At least some of the cores 104 and GPX 106 has an associated power control unit (PCU) 105. The PCU, among other things, administers power state changes for the cores and GPX in cooperation with the power management program 109 for managing at least part of the platform's power management strategy. (Note that while in this embodiment, the power management program 109 is implemented with software in the OS, it could also or alternatively be implemented in hardware or firmware, e.g., in the CPU and/or PCH chip.)

The cache 108 provides cache memory for the different cores and the GPX. It comprises a number of so-called ways, e.g., 16 ways (or lines), each including a number of memory bytes, e.g., 8 to 512 bytes. The cache may be fully loaded or only a portion of the lines may be used at any given time. A cache flush involves transferring the data to a different memory, e.g., to memory 111 and then powering down the cache. This may take a non negligible amount of overhead, depending upon the LLC load driven by the system activity to generate an event, e.g. a timer tick, an internal CPU/package timer event or an IO generated interrupt. In the past, the break-even time for a particular power down state was considered as a fixed value for a given CPU using its physical properties, e.g., enter latency, exit latency and energy penalty of entering/exit, etc. However closing different cache loads, depending on how fully loaded they are, incurs different overhead in terms of power consumption and latency. Thus a fixed break-even time is not optimal for all workloads. For example, the energy and latency it takes to flush and re-populate 16 lines of LLC is greater than that of 4 lines of LLC. If the energy break-even time is defined for the full cache, cache flush thus energy saving opportunities will be missed; on the other hand, if the break-even time is defined too small, the cache might be flushed too aggressively, causing energy and performance loss.

In order to fully optimize the opportunities to flush the LLC cache and enter deeper package power down states, the PCU employs an adaptive break-even time for improved CPU power management. Using an adaptive break-even time based on the number of LLC ways currently used by the cache improves the power saving opportunities. In some embodiments, the LLC ways may be independently power gated to further improve the LLC power and break-even energy time.

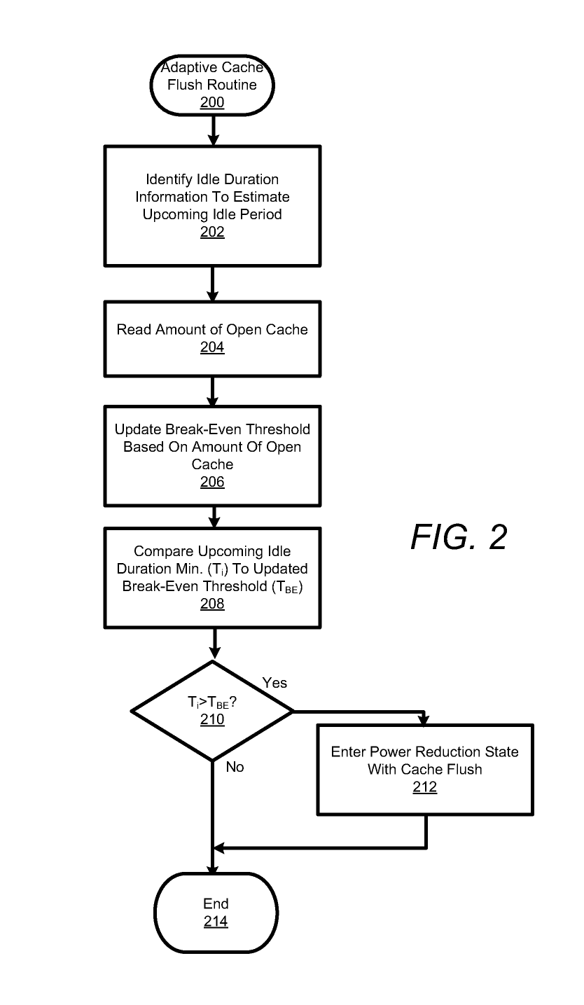

FIG. 2 is a flow diagram showing a routine 200 for implementing an adaptive cache flushing methodology. It is executed by the PCU to decide whether to enter a power down state where the cache is to be flushed based on the current idle duration and adaptive break-even time. Initially, at 202, it identifies idle duration information, e.g., from platform devices, timers, heuristics, etc, to determine or estimate the possible duration for an upcoming idle period. For this assessment, the logic (e.g., cores and GPX) using the LLC should be idle. That is, the cache should not be flushed if any logic (processing core, etc.) is kept active and needs to use it.

At 204, the routine reads the amount of open ways of the cache in the LLC. Based on this cache load level (e.g., how many ways are occupied), it updates the break-even threshold (T_{BE}) at 206. The more fully loaded the cache is, the greater will be the break even threshold time and visa versa. The break even threshold depends on the flush latency, re-load latency, and energy needed to perform the flushing and re-load operations, entering and exiting this low power state. At 208, it compares the upcoming idle duration, e.g. minimum estimated idle duration, (Tᵢ) to the updated break-even threshold (T_{BE}). At 210, it determines if Tᵢ>T_{BE}? If it is greater, then at 212, it enters a power reduction state (e.g., a C6, C7 or package C7 type deep sleep state) that results with a cache flush. From here, the routine ends at 214. Likewise, at 210, if it was determined that the idle duration is less then the updated break even time, then the routine proceeds to 214 and ends.

Returning back to step 202, it should be appreciated that the idle duration can be obtained in different ways, e.g., devices providing deterministic or opportunistic idle duration, CPU estimating idle duration based on heuristics, etc. In addition, in some embodiments, data coalescing schemes, or the like, may be employed to create idle periods that otherwise would not occur. In prior art schemes, with the non-deterministic nature of incoming network traffic, the communication interfaces (WiFi, WiMax, Ethernet, 3G, etc) transfer the data to the host and issue interrupts as soon as they receive it. On the other hand, data coalescing may be used to more efficiently group these tasks together. For example, in U.S. patent application Ser. No. 12/283,931, entitled: SYNCHRONIZATION OF MULTIPLE INCOMING NETWORK COMMUNICATION STREAMS, filed on Sep. 17, 2008, incorporated by reference herein, describes an architecture for synchronizing incoming data traffic across multi-communication devices. The application describes how regulating traffic, e.g., for a few milliseconds, doesn't materially impact the user experience but can create significant CPU saving opportunities by redistributing idle periods from short ones toward longer ones. By performing data coalescing on the platform, the short term transitions can be reduced by an order of magnitude and converted to longer term ones, enabling the processor to enter lower power states more often. That is, the determination at 210 (is Tᵢ>T_{BE}) will be satisfied more often.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a diagram. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a processor having a core and a cache for the core, the processor to define an adaptive break even flush time for the cache based on the cache load to implement flush operations for power reduction modes.

2. The apparatus of claim 1, in which the adaptive break even time is based on the latency and energy required for flushing the cache with its current load occupancy.

3. The apparatus of claim 1, in which a flush operation is performed when an idle duration exceeding the break-even time of the adaptive flush time is identified.

4. The apparatus of claim 3, in which the idle duration is based on idle duration information received from one or more devices.

5. The apparatus of claim 3, in which the idle duration is based on prediction using heuristic information

6. The apparatus of claim 4, in which the devices include an IO interface.

7. The apparatus of claim 6, in which the I/O interface coalesces device activities in order to create additional idle times.

8. The apparatus of claim 4, in which the processor is to coalesce servicing device tasks in order to create additional idle times.

9. The apparatus of claim 1, further comprising multiple cores to share the cache.

10. A computing platform, comprising:
a cache and a plurality of cores to share the cache; and
a power control unit (PCU) to control power reduction states for the cores and cache, the PCU to identify idle time for the cores and to flush the cache when the identified idle time exceeds an adaptive break even threshold.

11. The platform of claim 10, in which the adaptive break even threshold is proportional to the size of the cache load.

12. The platform of claim 10, in which the adaptive break even threshold is smaller for the cache when it is emptier.

13. The platform of claim 10, wherein the PCU identifies the idle time based on heuristics.

14. The platform of claim 10, in which the PCU identifies the idle time based at least in part on reported latency values from one or more platform devices.

15. The platform of claim 14, in which the devices coalesce interrupts to the cores to enhance idle time.

16. The platform of claim 10, in which the cores are part of a processor chip in a cellular telephone.

17. The platform of claim 10, in which the cores are part of a processor chip in a tablet computer.

18. A method, comprising:
identifying an upcoming idle time for a computing platform;
defining an adaptive break even threshold for cache in the platform based on a load level for the cache; and
entering a reduced power state resulting in the cache being flushed if the idle time is longer than the adaptive break even threshold.

19. The method of claim 18, wherein the adaptive break even threshold is non-linearly proportional to the cache load level.

20. The method of claim 18, wherein idle times are created by coalescing tasks for the platform, the idle times to be greater than the adaptive break even threshold.
